(19) United States
(12) Patent Application Publication
(10) Pub. No.: US 2026/0299218 A1
(43) Pub. Date: Oct. 1, 2026

(54) OPTICAL CONNECTION MODULE

(71) Applicant: Centera Photonics Inc., Hsinchu (TW)

(72) Inventors: Chin-Ta Chen, Hsinchu (TW); Kao-Feng Tsai, Hsinchu (TW)

(73) Assignee: Centera Photonics Inc., Hsinchu (TW)

(21) Appl. No.: 19/089,008

(22) Filed: Mar. 25, 2025

(51) Int. Cl. G02B 6/42; H04B 10/2507

(52) U.S. Cl. CPC G02B 6/4206; G02B 6/4257; H04B 10/2507

(57) ABSTRACT

An optical connection module, including a circuit substrate, an optical fiber array, a transimpedance amplifier, and a photoelectric conversion element. The optical fiber array is disposed on the circuit substrate and includes a transmission end. The transimpedance amplifier is disposed on the circuit substrate and is electrically connected to the circuit substrate. The transimpedance amplifier is flip-chip packaged onto the circuit substrate. The photoelectric conversion element contacts the transimpedance amplifier and is coupled to the transmission end. The photoelectric conversion element is disposed between the transimpedance amplifier and the transmission end to convert an optical signal into an electrical signal and then transmit the electrical signal to the transimpedance amplifier.

### BACKGROUND

### Technical Field

The disclosure relates to an electronic element, and in particular to an optical connection module.

### Description of Related Art

As applications in the communication field become increasingly widespread (e.g., virtual reality, the Internet of Things, high-performance computing, and artificial intelligence and machine learning (AI/ML)), data transmission rates are also gradually increasing. Global networks and data centers are also facing demands for higher bandwidth, lower latency, and lower signal loss.

Today, optical fibers have been widely used for data transmission over different distances. Pluggable optical transceivers offer advantages such as easy replacement, modularity, and the ability to enhance bandwidth density between devices and elements. However, as the demand for signal transmission capacity increases significantly, the higher frequency of signals also leads to an increase in high-frequency losses, resulting in excessive noise and signal distortion, which reduces transmission efficiency.

### SUMMARY

The disclosure provides an optical connection module, which may effectively reduce attenuation and distortion during signal transmission and improve optical coupling efficiency.

In an embodiment of the disclosure, an optical connection module including a circuit substrate, an optical fiber array, a transimpedance amplifier, and a photoelectric conversion element is provided. The optical fiber array is disposed on the circuit substrate and includes a transmission end. The transimpedance amplifier is disposed on the circuit substrate and is electrically connected to the circuit substrate. The transimpedance amplifier is flip-chip packaged onto the circuit substrate. The photoelectric conversion element contacts the transimpedance amplifier and is coupled to the transmission end. The photoelectric conversion element is disposed between the transimpedance amplifier and the transmission end to convert an optical signal into an electrical signal and then transmit the electrical signal to the transimpedance amplifier.

Based on the above, in the optical connection module of the disclosure, the photoelectric conversion element, which is used to be coupled to the transmission end of the optical fiber array, directly contacts the transimpedance amplifier. This may also be understood as the photoelectric conversion element being flip-chip packaged onto the transimpedance amplifier. When the photoelectric conversion element converts the optical signal emitted from the transmission end into an electrical signal, the electrical signal is transmitted to the transimpedance amplifier without passing through additional wire bonding or circuits. Accordingly, the transmission path of the electrical signal is shortened, and the medium type in the transmission channel is uniform, which reduces high-frequency electrical losses during the transmission of the electrical signal to the transimpedance amplifier and effectively improves the transmission quality of high-frequency signals in the optical connection module. Furthermore, in the optical connection module, since the transimpedance amplifier is flip-chip packaged onto the circuit substrate, the density of conductive paths in the circuit substrate may be increased, the volume and thickness of the circuit substrate may be reduced, and the transmission path of the electrical signal is shortened, which is also beneficial for reducing high-frequency losses of the circuit substrate.

To make the features and advantages of the disclosure more comprehensible, several embodiments accompanied with drawings are described in detail as follows.

### BRIEF DESCRIPTION OF THE DRAWINGS

FIG. 1 is a schematic structural diagram of an optical connection module according to an embodiment of the disclosure.

FIG. 2 is a perspective view of the optical connection module in FIG. 1.

FIG. 3 is an exploded view of the optical connection module in FIG. 1.

FIG. 4 is a schematic structural diagram of an optical connection module according to another embodiment of the disclosure.

FIG. 5 is a perspective view of the optical connection module in FIG. 4.

FIG. 6 is an exploded view of the optical connection module in FIG. 4.

### DESCRIPTION OF THE EMBODIMENTS

The terms “about,” “approximately,” “essentially,” or “substantially” as used herein include the stated value and an average value within an acceptable deviation range determined by a person having ordinary skill in the art, considering the specific amount of measurement and measurement-related errors (i.e., limitations of the measurement system). For example, “about” may indicate within one or more standard deviations of the stated value or within ±30%, ±20%, ±15%, ±10%, or ±5%, for example. Furthermore, the terms “about,” “approximately,” “essentially,” or “substantially” as used herein may be selected to define a more acceptable deviation range or standard deviation depending on measurement properties, cutting properties, or other properties, rather than applying a single standard deviation to all properties.

In the drawings, for clarity, the thickness of layers, films, panels, and regions is enlarged. It should be understood that when an element such as a layer, film, region, or substrate is described as being “on” or “connected to” another element, it may be directly on or connected to the other element, or an intermediate element may also be present. Conversely, when an element is described as being “directly on” or “directly connected to” another element, no intermediate element is present. As used herein, “connected” may refer to physical and/or electrical connections.

Exemplary embodiments of the disclosure will now be described in detail, with examples of the exemplary embodiments being illustrated in the accompanying drawings. Whenever possible, the same reference numerals are used in the figures and descriptions to indicate the same or similar parts.

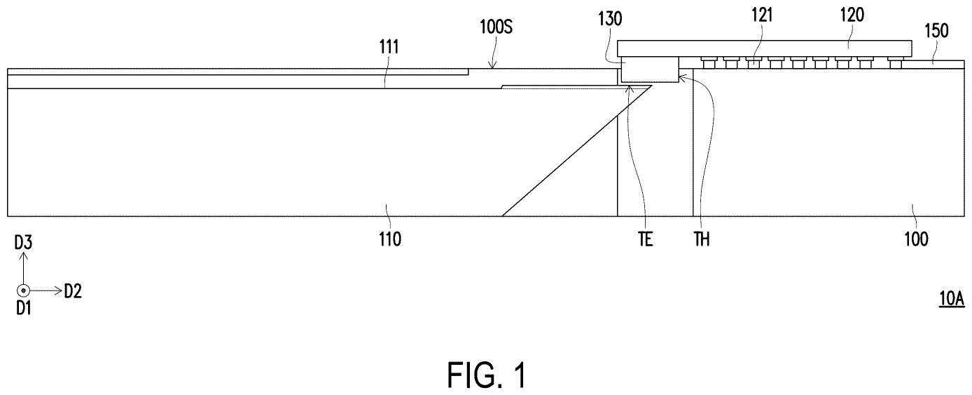

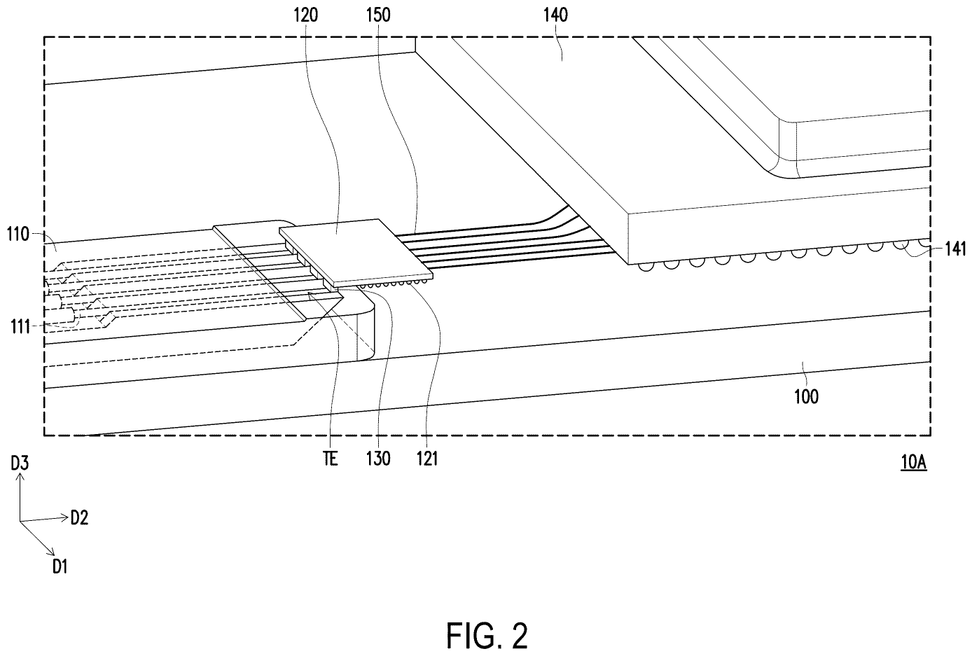

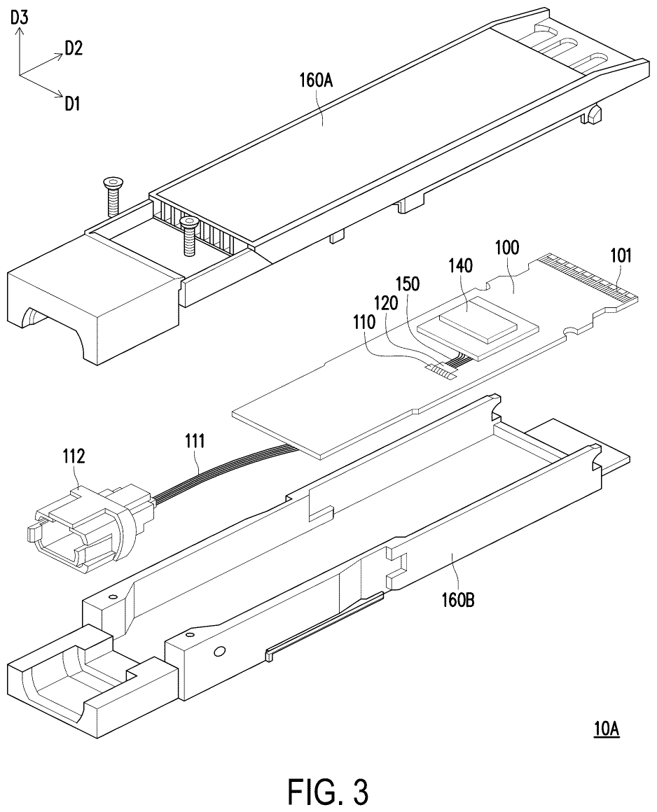

FIG. 1 is a schematic structural diagram of an optical connection module according to an embodiment of the disclosure. FIG. 2 is a perspective view of the optical connection module in FIG. 1. FIG. 3 is an exploded view of the optical connection module in FIG. 1. Referring to FIGS. 1, 2, and 3 at the same time, an optical connection module 10A includes a circuit substrate 100, an optical fiber array 110, a transimpedance amplifier 120, and a photoelectric conversion element 130. The optical fiber array 110 is disposed on the circuit substrate 100 and includes a transmission end TE, which is adapted to transmit an optical signal carrying encoded information for information transmission but is not limited thereto. The transimpedance amplifier 120 is disposed on the circuit substrate 100 and is electrically connected to the circuit substrate 100. Regarding the relative positions of the elements, in a third direction D3 (which may also be understood as the thickness direction of the optical connection module 10A), the photoelectric conversion element 130 is disposed between the transimpedance amplifier 120 and the transmission end TE of the optical fiber array 110 to convert the optical signal emitted from the transmission end TE into an electrical signal and then transmit the electrical signal to the transimpedance amplifier 120.

The circuit substrate 100 may be a printed circuit board (PCB) or a flexible circuit board (FCB), but the disclosure is not limited thereto. In some embodiments, the circuit substrate 100 may be any one of a multi-layer PCB, a high density interconnector PCB (HDI PCB), or a high frequency printed circuit board (HF PCB), but the disclosure is not limited thereto. Specifically, when the circuit substrate 100 is a high-frequency printed circuit board, it may have a lower relative permittivity (Dk) and a lower dissipation factor (Df), which allows the high-frequency loss of the optical connection module 10A to be reduced.

The optical fiber array 110 may include multiple optical fibers 111 and an interface 112. For example, in FIG. 2, an embodiment is schematically illustrated in which the optical fiber array 110 includes four optical fibers 111, and the four optical fibers 111 are arranged in parallel in a first direction D1, with each optical fiber 111 extending in a second direction D2. FIG. 3 illustrates the interface 112, which is connected to the multiple optical fibers 111. In the second direction D2, the transmission end TE and the interface 112 are located at opposite ends of the optical fibers 111. In the disclosure, the first direction D1, the second direction D2, and the third direction D3 may all be different from each other. For example, the first direction D1, the second direction D2, and the third direction D3 may be substantially perpendicular to each other in any pairwise combination, but the disclosure is not limited thereto.

Furthermore, in some embodiments, the number of the optical fiber arrays 110 may be two. Therefore, the number of the optical fibers 111 in the optical connection module 10A, as well as the corresponding number of the transmission ends TE, may be eight. In other words, the optical connection module 10A may be an octal small formfactor pluggable (OSFP) module, but the disclosure is not limited thereto. On the other hand, the optical fiber 111 may be a single-mode fiber, further including a core and a cladding layer covering the core (both not shown). The optical fiber 111 may also be a multi-mode fiber, further including an optical waveguide of the core, a cladding layer covering the optical waveguide, a buffer layer, and an outer jacket (all not shown), but the disclosure is not limited thereto. The core material of the optical fiber 111 may include plastic, glass, silica, a composite material of the above, or other materials, but the disclosure is not limited thereto. The wavelength of the optical signal transmitted by the optical fiber 111 may be 1271 nanometers (nm), 1291 nm, 1311 nm, 1331 nm, or other wavelength ranges, but the disclosure is also not limited thereto.

The photoelectric conversion element 130 may be a photodiode, used to be coupled to the transmission end TE of the optical fiber 111. For example, the photoelectric conversion element 130 may be separated from the transmission end TE by a gap and connected to the transmission end TE using an optically transparent adhesive or a connector (both not shown), but the disclosure is not limited thereto. The photoelectric conversion element 130 is used to convert the optical signal transmitted by the transmission end TE into an electrical current signal (e.g., photocurrent).

On the other hand, in an embodiment where the number of the optical fibers 111 is plural (e.g., four or eight), the number of the photoelectric conversion elements 130 corresponding to the multiple transmission ends TE may also be plural (e.g., four or eight). In the third direction D3, the multiple photoelectric conversion elements 130 may also overlap the multiple transmission ends TE respectively, but the disclosure is not limited thereto.

The transimpedance amplifier (TIA) 120 is used to convert the electrical current signal into an electrical voltage signal and amplify the signal. The transimpedance amplifier 120 may be an integrated circuit (IC) and directly disposed on an upper surface 100S of the circuit substrate 100. In this embodiment, the transimpedance amplifier 120 is flip-chip packaged onto the circuit substrate 100. For example, the optical connection module 10A may further include multiple leads 121, which electrically connect the transimpedance amplifier 120 to the circuit substrate 100, wherein the leads 121 are located between the transimpedance amplifier 120 and the circuit substrate 100. In an embodiment, the leads 121 may be directly electrically connected to pads (not shown) on the upper surface 100S of the circuit substrate 100, meaning that the leads 121 contact the pads, but the disclosure is not limited thereto. In some embodiments, the circuit substrate 100 may be manufactured using a modified Semi-Additive Process (mSAP), and the transimpedance amplifier 120 may be flip-chip packaged onto the circuit substrate 100. Therefore, the density of conductive paths in the circuit substrate 100 may be increased, the volume and thickness of the circuit substrate 100 may be reduced, and the transmission path of the electrical signal is shortened, which is also beneficial for reducing high-frequency losses of the circuit substrate 100.

It is specifically noted that, in the disclosure, the photoelectric conversion element 130 directly contacts the transimpedance amplifier 120. For example, in the optical connection module 10A, the photoelectric conversion element 130 is directly disposed on the transimpedance amplifier 120 on the side facing the upper surface 100S. From another perspective, the photoelectric conversion element 130 and the leads 121 of the transimpedance amplifier 120 are both located on the same side of the transimpedance amplifier 120. Since the photoelectric conversion element 130 is not electrically connected to the transimpedance amplifier 120 through wire bonding technology (which may also be understood as the photoelectric conversion element 130 being flip-chip packaged onto the transimpedance amplifier 120), the density of the leads of each chip (e.g., the transimpedance amplifier 120) on the circuit substrate 100 may be increased. Furthermore, by omitting the bonding wires and soldering materials used in wire bonding, unnecessary interface reflections and energy losses may be reduced, and the channel length may be shortened. As a result, when the electrical signal is transmitted from the photoelectric conversion element 130 to the transimpedance amplifier 120, high-frequency losses and noise of the electrical signal may be effectively reduced. This enhances the electrical performance of the optical connection module 10A and reduces the packaging volume. Accordingly, the electrical signal transmitted by the optical connection module 10A may have a higher signal-to-noise ratio (SNR), allowing the optical connection module 10A to provide good optoelectronic coupling performance during high-speed transmission.

Additionally, the optical connection module 10A may further include a digital signal processor 140 (DSP). Specifically, the digital signal processor 140 is disposed on the circuit substrate 100. The digital signal processor 140 may be an integrated circuit and include multiple leads 141, wherein the leads 141 may be electrically connected to pads (not shown) on the circuit substrate 100 to receive the required power or transmit electrical signals through the circuit substrate 100, but the disclosure is not limited thereto. The digital signal processor 140 may convert the voltage signal generated by the transimpedance amplifier 120 into a digital signal and transmit the converted digital signal to the circuit substrate 100. Finally, the digital signal may be transmitted through gold fingers 101 of the circuit substrate 100 to a server or a computer (not shown).

Furthermore, the circuit substrate 100 may further include a redistribution layer 150, and the digital signal processor 140 is electrically connected to the transimpedance amplifier 120 through the redistribution layer 150. Specifically, in the second direction D2, two opposite ends of the redistribution layer 150 may be electrically connected to the leads 121 and the leads 141, respectively. The redistribution layer 150 may be a high-frequency routing layer on the circuit substrate 100. For example, the redistribution layer 150 may be entirely linear or have arc-shaped bends at turning points, and the redistribution layer 150 may have a shorter length. Accordingly, after the photoelectric conversion element 130 converts the optical signal emitted from the transmission end TE into an electrical signal, the electrical signal may be sequentially transmitted through the photoelectric conversion element 130, the transimpedance amplifier 120, the leads 121, the redistribution layer 150, and the leads 141 to the digital signal processor 140 for corresponding signal processing.

In some embodiments, the transmission capacity of the transmission end TE of each optical fiber 111 may be substantially 400 gigabits per second per channel (which may also be understood as 400 Gbps per channel; 400*10⁹ bits per second per channel). In an embodiment where the optical connection module 10A is an OSFP module, the total transmission capacity of the optical connection module 10A may reach 3.2 T (bps), but the disclosure is not limited thereto.

Referring again to FIG. 1, in this embodiment, the optical connection module 10A may further include a blind via TH, and a portion of the photoelectric conversion element 130 is embedded in the blind via TH. The optical fiber array 110 is further disposed in the circuit substrate 100. Specifically, the transmission end TE of the optical fiber array 110 may emit an optical signal in the third direction D3, allowing the light-receiving surface of the photoelectric conversion element 130 located in the blind via TH to receive the optical signal. On the other hand, even if the photoelectric conversion element 130 has a relatively large thickness, a space accommodating the photoelectric conversion element 130 may be formed using the design of the blind via TH. This enhances the assembly tolerance of the elements in the optical connection module 10A and facilitates the fixation of the photoelectric conversion element 130 onto the circuit substrate 100.

Referring again to FIG. 3, the optical connection module 10A may further include a housing to protect the elements. For example, the optical connection module 10A may include a first housing 160A and a second housing 160B. The first housing 160A is disposed on the circuit substrate 100, and the circuit substrate 100 is disposed between the first housing 160A and the second housing 160B. The first housing 160A and the second housing 160B may form an accommodating space, allowing the circuit substrate 100 (and the above electronic elements) to be located within the accommodating space. In the second direction D2, the first housing 160A and the second housing 160B may also have two opposite openings to expose the interface 112 and the gold fingers 101, facilitating the reception of optical signals and the transmission of electrical signals by the optical connection module 10A, but the disclosure is not limited thereto.

Some other embodiments will be provided below to describe the disclosure in detail, wherein the same components are designated with the same reference numerals, and descriptions of the same technical content are omitted. For omitted parts, please refer to the previous embodiments, and further explanations will not be repeated below.

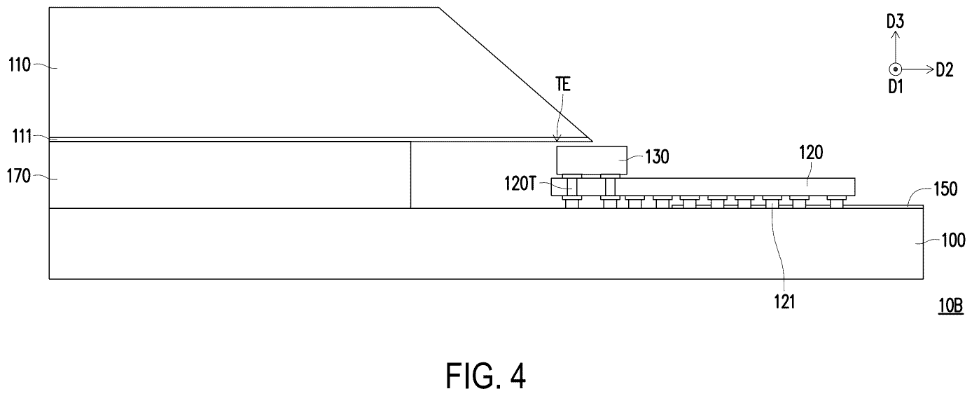

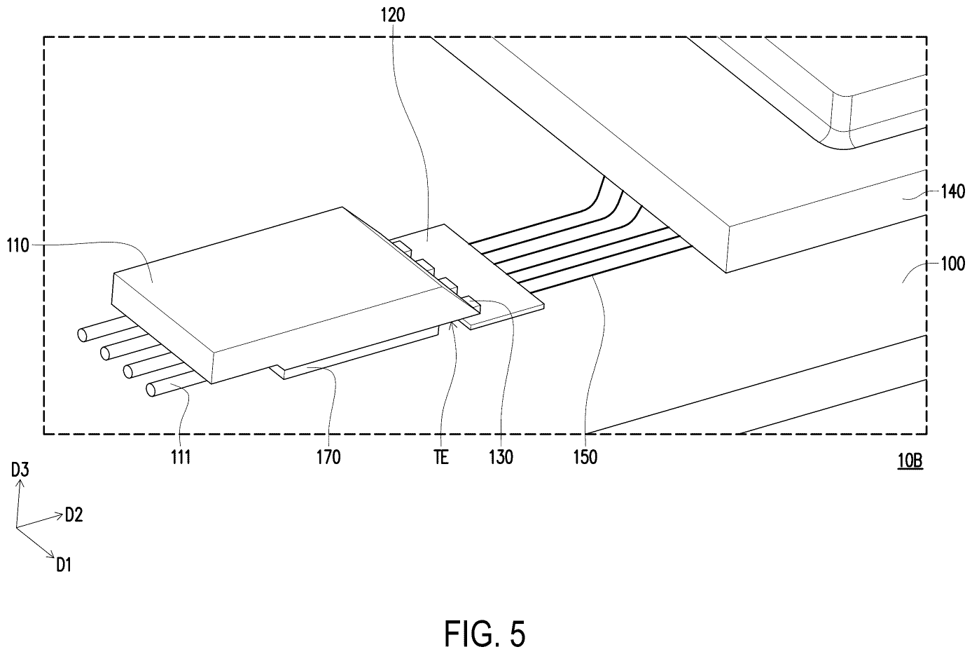

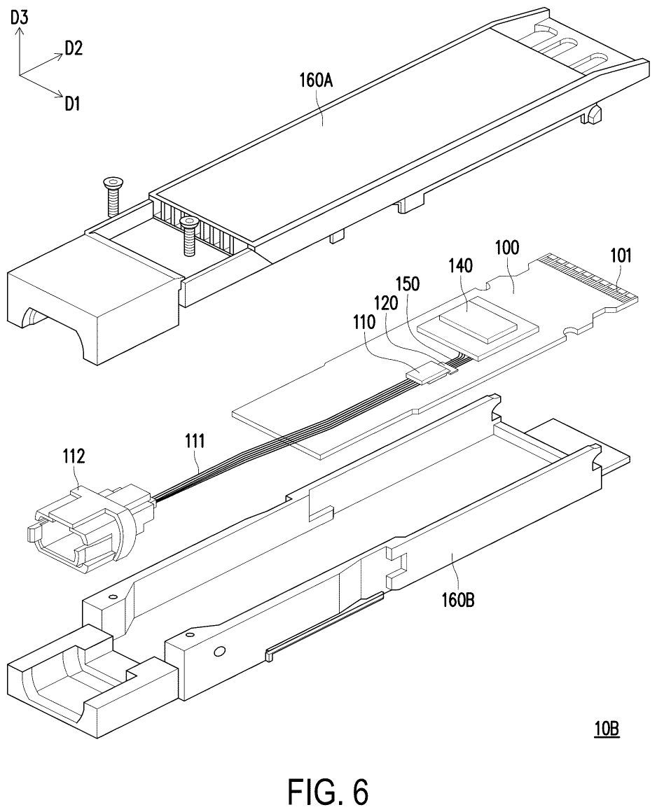

FIG. 4 is a schematic structural diagram of an optical connection module according to another embodiment of the disclosure. FIG. 5 is a perspective view of the optical connection module in FIG. 4. FIG. 6 is an exploded view of the optical connection module in FIG. 4. Referring to FIGS. 4, 5, and 6 at the same time, an optical connection module 10B is similar to the optical connection module 10A, with the main difference being that the optical fiber array 110 of the optical connection module 10B is disposed on the upper surface 100S. For example, in the thickness direction of the circuit substrate 100, the circuit substrate 100, the transimpedance amplifier 120, the photoelectric conversion element 130, and the transmission end TE of the optical fiber 111 are sequentially arranged.

Specifically, in this embodiment, the photoelectric conversion element 130 is disposed on the side of the transimpedance amplifier 120 opposite to the leads 121. From another perspective, in the third direction D3, the leads 121 and the photoelectric conversion element 130 are located on opposite sides of the transimpedance amplifier 120. The photoelectric conversion element 130 may also contact the transimpedance amplifier 120 using flip-chip packaging. For example, in this embodiment, the transimpedance amplifier 120 may further include a conductive via 120T, and the photoelectric conversion element 130 is electrically connected to the transimpedance amplifier 120 via the conductive via 120T. Therefore, after the optical signal emitted from the optical fiber array 110 is transmitted through the transmission end TE to the photoelectric conversion element 130, the photoelectric conversion element 130 may convert the optical signal into an electrical signal (e.g., a current signal) and sequentially transmit the electrical signal to the conductive via 120T, the transimpedance amplifier 120, the leads 121, the redistribution layer 150, and the digital signal processor 140. After converting the voltage signal into a digital signal, the digital signal processor 140 then transmits the digital signal to the gold fingers 101 for transmission outside the optical connection module 10B.

On the other hand, the optical connection module 10B may further include a fixing element 170, used to fix the optical fiber array 110 onto the circuit substrate 100. For example, in the third direction D3, the fixing element 170 may be disposed between the optical fiber array 110 and the circuit substrate 100 to prevent the optical fiber array 110 from shifting on the circuit substrate 100, ensuring the structural strength and stability of the optical connection module 10B. In some implementations, the fixing element 170 may be a soldering material, an adhesive layer, or a pressure sensitive adhesive (PSA), but the disclosure is not limited thereto.

In summary, in the optical connection module of the disclosure, the photoelectric conversion element, which is used to be coupled to the transmission end of the optical fiber array, directly contacts the transimpedance amplifier. This may also be understood as the photoelectric conversion element being flip-chip packaged onto the transimpedance amplifier. When the photoelectric conversion element converts the optical signal emitted from the transmission end into an electrical signal, the electrical signal is transmitted to the transimpedance amplifier without passing through additional wire bonding or circuits. Accordingly, the transmission path of the electrical signal is shortened, and the medium type in the transmission channel is uniform, which reduces high-frequency electrical losses during the transmission of the electrical signal to the transimpedance amplifier and effectively improves the transmission quality of high-frequency signals in the optical connection module. Furthermore, in the optical connection module of the disclosure, since the transimpedance amplifier is flip-chip packaged onto the circuit substrate, the density of conductive paths in the circuit substrate may be increased, the volume and thickness of the circuit substrate may be reduced, and the transmission path of the electrical signal is shortened, which is also beneficial for reducing high-frequency losses of the circuit substrate.

Although the disclosure has been described with reference to the above embodiments, they are not intended to limit the disclosure. It will be apparent to one of ordinary skill in the art that modifications to the described embodiments may be made without departing from the spirit and the scope of the disclosure. Accordingly, the scope of the disclosure will be defined by the attached claims and their equivalents and not by the above detailed descriptions.

What is claimed is:

1. An optical connection module, comprising:
a circuit substrate;
an optical fiber array, disposed on the circuit substrate and comprising a transmission end, wherein the optical fiber array is adapted to transmit an optical signal;
a transimpedance amplifier, disposed on the circuit substrate and electrically connected to the circuit substrate, wherein the transimpedance amplifier is flip-chip packaged onto the circuit substrate; and
a photoelectric conversion element, contacting the transimpedance amplifier and coupled to the transmission end, wherein the photoelectric conversion element is disposed between the transimpedance amplifier and the transmission end to convert the optical signal into an electrical signal and then transmit the electrical signal to the transimpedance amplifier.

2. The optical connection module according to claim 1, further comprising a digital signal processor disposed on the circuit substrate.

3. The optical connection module according to claim 2, wherein the circuit substrate further comprises a redistribution layer, and the digital signal processor is electrically connected to the transimpedance amplifier through the redistribution layer.

4. The optical connection module according to claim 1, wherein the circuit substrate further comprises a blind via, the photoelectric conversion element is partially embedded in the blind via, and the optical fiber array is further disposed in the circuit substrate.

5. The optical connection module according to claim 1, further comprising a plurality of leads electrically connecting the transimpedance amplifier to the circuit substrate, wherein the plurality of leads are located between the transimpedance amplifier and the circuit substrate, and the photoelectric conversion element and the plurality of leads are located on a same side of the transimpedance amplifier.

6. The optical connection module according to claim 1, wherein the circuit substrate, the transimpedance amplifier, the photoelectric conversion element, and the transmission end are sequentially arranged in a thickness direction of the circuit substrate.

7. The optical connection module according to claim 1, further comprising a plurality of leads electrically connecting the transimpedance amplifier to the circuit substrate, wherein the plurality of leads are located between the transimpedance amplifier and the circuit substrate, and the photoelectric conversion element and the plurality of leads are respectively located on two opposite sides of the transimpedance amplifier.

8. The optical connection module according to claim 1, wherein the transimpedance amplifier further comprises a conductive via, and the photoelectric conversion element is electrically connected to the transimpedance amplifier through the conductive via.

9. The optical connection module according to claim 1, wherein a number of the transmission end is plural, and a number of the photoelectric conversion element is plural, the plurality of photoelectric conversion elements overlapping the plurality of transmission ends respectively.

10. The optical connection module according to claim 9, wherein a transmission capacity of the transmission end is substantially 400 gigabits per second per channel.

11. The optical connection module according to claim 10, wherein the number of the plurality of transmission ends is eight.

12. The optical connection module according to claim 1, further comprising:
a first housing, disposed on the circuit substrate; and
a second housing, wherein the circuit substrate is disposed between the first housing and the second housing.
